(19) United States
(12) Patent Application Publication
(10) Pub. No.: US 2023/0090844 A1
(43) Pub. Date: Mar. 23, 2023

(54) SYSTEM AND METHOD FOR AVOIDING COLLISION FOR VEHICLE

(71) Applicant: HYUNDAI MOBIS Co., Ltd., Seoul (KR)

(72) Inventor: Joo Suc PARK, Yongin-si (KR)

(73) Assignee: HYUNDAI MOBIS Co., Ltd., Seoul (KR)

(21) Appl. No.: 17/881,166

(22) Filed: Aug. 4, 2022

(30) Foreign Application Priority Data
Sep. 17, 2021 (KR) 10-2021-0125044

(51) Int. Cl. B60W 30/09; G06V 20/58

(52) U.S. Cl. CPC B60W 30/09; G06V 20/58; B60W 2420/42; B60W 2520/16; B60W 2552/30; B60W 2510/20

(57) ABSTRACT

The present disclosure relates to a system and a method for avoiding a collision for a vehicle. The system includes an operation determining device for determining whether the vehicle has entered a parking lot based on location information and inclination information of the vehicle, and a controller that generates a virtual map about an obstacle on a curved road in the parking lot based on image information and distance information when it is determined that the vehicle has entered the parking lot, generates an expected movement trajectory of the vehicle based on steering information and speed information of the vehicle, and predicts the collision of the obstacle in the virtual map and the vehicle depending on the expected movement trajectory based on the virtual map and the expected movement trajectory.

### CROSS-REFERENCE TO RELATED APPLICATION

This application claims the benefit of priority to Korean Patent Application No. 10-2021-0125044, filed in the Korean Intellectual Property Office on Sep. 17, 2021, the entire contents of which are incorporated herein by reference.

### TECHNICAL FIELD

The present disclosure relates to a system and a method for avoiding a collision for a vehicle.

### BACKGROUND

A vehicle refers to a device capable of transporting people or goods to a destination while traveling on a road or a line and is able to move to various locations mainly using at least one wheel installed on a vehicle body.

Recently, to reduce a burden of a driver and improve convenience, research on a vehicle equipped with a state-of-the-art driver support system that actively provides information about a vehicle state, a driver state, and a surrounding environment is being actively conducted.

However, a technology performed in a vehicle traveling on a lane occupies most of the general driver support system.

In a case of an inexperienced driver, accidents in which a vehicle and a wall surface collide with each other on a curved slope of a narrow width, such as an entrance and exit of an indoor parking lot, or a wheel of the vehicle is damaged by a curb frequently occur, so that it is urgent to develop technology for reducing such accidents.

### SUMMARY

The present disclosure has been made to solve the above-mentioned problems occurring in the prior art while advantages achieved by the prior art are maintained intact.

An aspect of the present disclosure provides a system and a method for avoiding a collision for a vehicle that may prevent collision accidents that may occur at an entrance and exit of an indoor parking lot.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a system for a vehicle to avoid a collision includes an operation determining device to determine whether the vehicle has entered a parking lot based on location information and inclination information of the vehicle, and a controller that generates a virtual map about an obstacle on a curved road in the parking lot based on image information and distance information when it is determined that the vehicle has entered the parking lot, generates an expected movement trajectory of the vehicle based on steering information and speed information of the vehicle, and predicts the collision between the obstacle in the virtual map and the vehicle depending on the expected movement trajectory based on the virtual map and the expected movement trajectory.

In one implementation, the operation determining device may determine that, when it is determined that the vehicle has reached the parking lot based on the location information, the vehicle is travelling on a slope of the parking lot when a pitch angle exceeds or is below a preset range based on the inclination information.

In one implementation, the obstacle may include a wall surface and a curb of the curved road.

In one implementation, the controller may, when receiving information obtained by determining that the vehicle has entered the parking lot from the operation determining device, recognize the wall surface and the curb of the curved road based on the image information obtained from a region in front of the vehicle, and generate the virtual map based on the recognized wall surface and curb.

In one implementation, the controller may correct an error of the virtual map with respect to the wall surface and the curb based on the distance information provided from an ultrasonic sensor.

In one implementation, the controller may predict a collision between the vehicle and a wall surface or a curb in the virtual map when the vehicle travels with the expected movement trajectory based on an overall width, an overall length, and a location of each wheel of the vehicle.

In one implementation, the controller may generate warning notification information for each collision-predicted-distance between the vehicle and the wall surface or the curb when the collision between the vehicle and the wall surface or the curb in the virtual map is predicted.

In one implementation, the system may further include a notification device to provide the warning notification information to a driver as at least one of visual information or auditory information when receiving the warning notification information.

In one implementation, the controller may generate braking information when the collision between the vehicle and the wall surface or the curb in the virtual map is predicted and when a distance between the vehicle and the wall surface or the curb predicted to collide with the vehicle is below a preset distance.

In one implementation, the system may further include a braking device to stop the vehicle when receiving the braking information.

In one implementation, the system may further include a navigation to provide the location information, a pitch sensor to provide the inclination information, a camera installed at a front portion of the vehicle to provide the image information, an ultrasonic sensor to provide the distance information, a steering sensor to provide the steering information, and a speed sensor to provide the speed information.

In one implementation, the virtual map and the expected movement trajectory may be provided to a driver as visual information by a display device installed in the vehicle.

According to another aspect of the present disclosure, a method for a vehicle to avoid a collision includes determining, by an operation determining device, whether the vehicle is traveling on an inclined curved road of a parking lot, recognizing, by a controller, a wall surface and a curb of the inclined curved road based on an image of a region in front of the vehicle, generating, by the controller, a virtual map about the recognized wall surface and curb, calculating, by the controller, an expected movement trajectory of the vehicle based on steering information and speed information, and predicting, by the controller, the collision of the vehicle with the wall surface or the curb in the virtual map based on the expected movement trajectory and the virtual map.

In one implementation, the method may further include correcting, by the controller, an error of the virtual map based on distance information collected from an ultrasonic sensor.

In one implementation, the predicting of the collision may include predicting, by the controller, the collision between the vehicle and the wall surface or the curb in the virtual map when the vehicle travels with the expected movement trajectory based on an overall width, an overall length, and a location of each wheel of the vehicle.

In one implementation, the method may further include providing, by the controller, a warning notification information to a driver for each collision-predicted-distance between the vehicle and the wall surface or the curb when the collision is predicted in the predicting of the collision.

In one implementation, the method may further include stopping, by a braking device, the vehicle when the collision is predicted in the predicting of the collision and when a collision-predicted-distance between the wall surface or the curb and the vehicle is smaller than a preset distance.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram showing a configuration of a collision avoidance system for a vehicle according to an embodiment of the present disclosure;

FIG. 2 is a diagram showing a flowchart for illustrating operations of a collision avoidance system for a vehicle according to an embodiment of the present disclosure; and

FIGS. 3 and 4 are diagrams for illustrating a collision avoidance system for a vehicle according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These tams are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

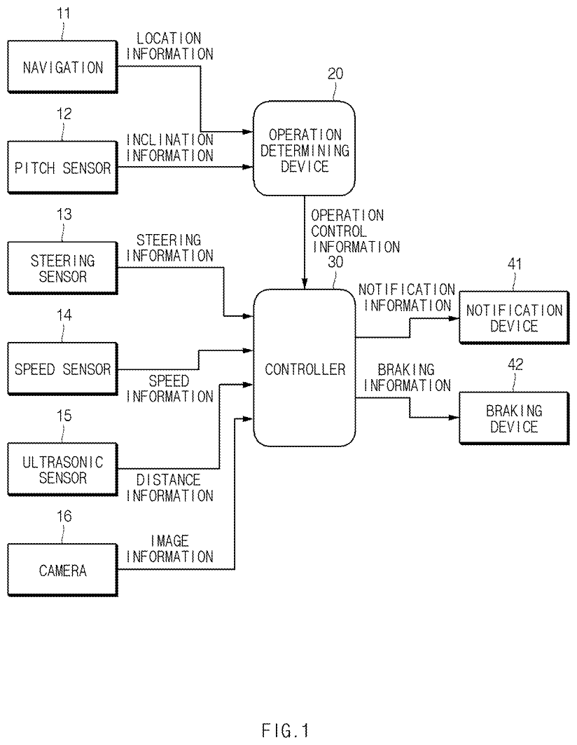

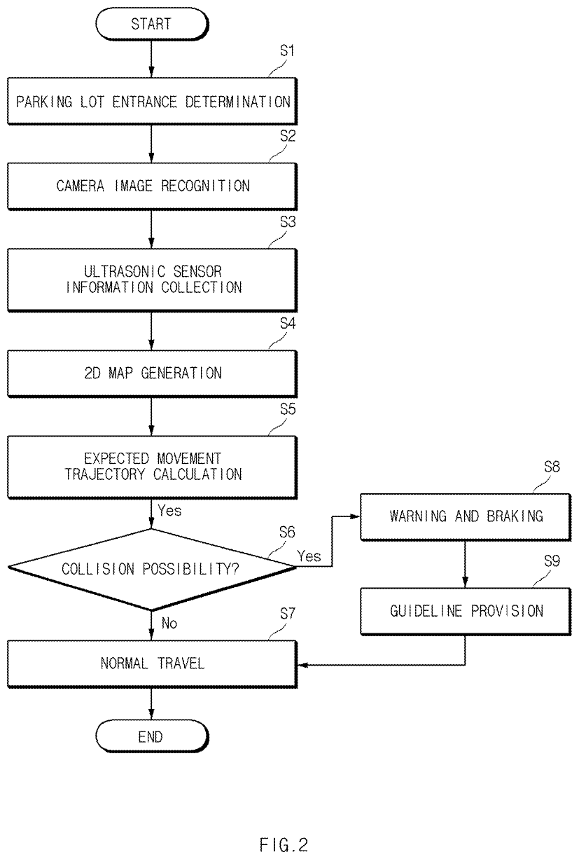

Hereinafter, embodiments of the present disclosure will be described in detail with reference to FIGS. 1 and 2.

Referring to FIG. 1, a collision avoidance system for a vehicle according to an embodiment of the present disclosure may include a navigation 11, a pitch sensor 12, a steering sensor 13, a speed sensor 14, an ultrasonic sensor 15, a camera 16, an operation determining device 20, a controller 30, a notification device 41, and a braking device 42.

The navigation 11 may provide location information of a vehicle to the operation determining device 20.

The pitch sensor 12 may sense a pitch angle of the vehicle and provide the pitch angle to the operation determining device 20 as inclination information.

The steering sensor 13 may sense a steering angle of the vehicle and provide the steering angle to the controller 30 as steering information.

The speed sensor 14 may sense a speed of the vehicle and provide the speed to the controller 30 as speed information.

The ultrasonic sensor 15 may sense a distance between an object around the vehicle and the vehicle and provide the distance to the controller 30 as distance information.

The camera 16 may obtain an image of a region around the vehicle and provide the image to the controller 30 as image information.

In this regard, the camera 16 may obtain an image of a region in front of the vehicle and provide the obtained image to the controller 30.

The operation determining device 20 may generate operation control information for controlling whether to activate the controller 30 by determining whether the vehicle has entered an indoor parking lot based on the location information of the vehicle provided from the navigation 11 and the inclination information provided from the pitch sensor 12.

For example, when it is determined based on the location information and the inclination information of the vehicle that the vehicle has entered the indoor parking lot, the operation determining device 20 may generate the operation control information capable of activating the controller 30.

More specifically, when it is determined based on the location information of the vehicle that the vehicle has reached the indoor parking lot and when the pitch angle of the vehicle exceeds a preset range or is below the preset range based on the inclination information, the operation determining device 20 may determine that the vehicle has entered the indoor parking lot.

In general, an entrance and exit of the indoor parking lot has a sharp inclination, so that the operation determining device 20 may determine that the vehicle has reached the entrance and exit of the indoor parking lot using the pitch angle.

In addition, because the entrance and exit of the indoor parking lot generally has a form of a curved road having a large curvature, hereinafter, the entrance and exit may include the curved road.

In one example, when it is determined based on the location information of the vehicle that the vehicle has not entered the indoor parking lot or has exited the indoor parking lot, the operation determining device 20 may generate the operation control information capable of deactivating the controller 30.

In more detail, when the vehicle moves away from the indoor parking lot based on the location information of the vehicle, the operation determining device 20 may generate the operation control information capable of deactivating the controller 30.

Whether to activate the controller 30 may be determined based on the operation control information provided from the operation determining device 20.

When the controller 30 is activated, notification information and braking information may be generated based on the steering information, the speed information, the distance information, and the image information.

In this regard, the controller 30 may provide the generated notification information to the notification device 41, and may provide the braking information to the braking device 42.

When being deactivated, the controller 30 may stop generating the notification information and the braking information based on the steering information, the speed information, the distance information, and the image information.

In detail, when being activated, the controller 30 may recognize a wall surface and a curb installed at the entrance and exit of the indoor parking lot based on the image information.

In this regard, the controller 30 may calculate a width between the two wall surfaces opposite to each other and a vertical dimension and a width of the curb based on the image information.

In addition, the controller 30 may correct, based on the distance information, errors of the width between the two wall surfaces (a width of the entrance and exit) and the vertical dimension and the width of the curb calculated based on the image information.

In addition, the controller 30 may convert the entrance and exit of the indoor parking lot recognized based on the image information and the distance information into a two-dimensional virtual map.

The controller 30 may calculate an expected movement trajectory of the vehicle based on the steering information and the speed information.

When the vehicle travels with the expected movement trajectory calculated based on an overall length, an overall width, and a location of each wheel of the vehicle, the controller 30 may predict whether the vehicle will collide with the wall surface or the curb converted into the two-dimensional virtual map.

When the collision of the vehicle with the wall surface or the curb recognized with the two-dimensional virtual map is predicted based on the expected movement trajectory of the vehicle, the controller 30 may generate the notification information for warning a driver for each distance between the vehicle and an obstacle (the wall surface or the curb) at which the collision is predicted.

In this regard, the controller 30 may provide the generated notification information to the notification device 41.

In addition, when the collision of the vehicle with the wall surface or the curb recognized with the two-dimensional virtual map is predicted based on the expected movement trajectory of the vehicle, the controller 30 may generate the braking information for braking the vehicle when the distance between the vehicle and the obstacle (the wall surface or the curb) at which the collision is predicted is smaller than a preset distance.

In this regard, the controller 30 may provide the generated braking information to the braking device 42.

The notification device 41 may provide a warning notification about the collision prediction to the driver as at least one of visual information or auditory information.

For example, the notification device 41 may include at least one of a cluster, a speaker, or an AVN (Audio Video Navigation) system.

The braking device 42 may include a brake and may decelerate or stop the vehicle when the braking information is received.

Operations of the collision avoidance system for the vehicle according to one embodiment of the present disclosure constructed as such are as follows.

When it is determined based on the location information of the vehicle provided from the navigation 11 that the vehicle has reached the indoor parking lot, and when the pitch angle exceeds the preset range or is below the preset range based on the inclination information about the pitch angle provided from the pitch sensor 12, the operation determining device 20 may determine that the vehicle is traveling at the entrance and exit having a slope of the indoor parking lot.

For example, it may be determined that the vehicle is traveling on a flat ground when the pitch angle is 0 degrees, it may be determined that the vehicle is traveling on a downhill road when the pitch angle decreases to a negative number, and it may be determined that the vehicle is traveling on an uphill road when the pitch angle increases to a positive number.

Therefore, the operation determining device 20 may determine with the location information of the vehicle provided from the navigation 11 that the vehicle has reached the indoor parking lot, and may determine based on the inclination information containing the pitch angle that the vehicle is traveling at the entrance and exit having the slope of the indoor parking lot.

When it is determined that the vehicle is traveling at the entrance and exit of the indoor parking lot, the operation determining device 20 may generate the operation control information capable of activating the controller 30.

Eventually, the controller 30 may be activated when it is determined by the operation determining device 20 that the vehicle is traveling at the entrance and exit of the indoor parking lot.

The activated controller 30 may recognize the wall surface and the curb of the entrance and exit based on the image of the region in front of the vehicle provided from the camera 16, and generate the virtual map based on the recognized information.

In addition, the controller 30 may correct an error of the information recognized with the image based on the distance information provided from the ultrasonic sensor 15 and apply the corrected information to the generated virtual map.

After the virtual map in which the wall surface and the curb for the entrance and exit of the indoor parking lot are recognized is generated by the controller 30, the controller 30 may calculate the expected movement trajectory of the vehicle based on the steering information and the speed information respectively provided from the steering sensor 13 and the speed sensor 14.

When the vehicle travels with the expected movement trajectory based on the calculated expected movement trajectory and the overall width, the overall length, and the location of each wheel of the vehicle, the controller 30 may predict the collision of the vehicle with the wall surface or the curb of the virtual map.

In this regard, the controller 30 may provide the warning notification to the driver or stop the vehicle when the collision of the vehicle traveling with the expected movement trajectory with the wall surface or the curb is predicted.

More specifically, when the collision is predicted, the controller 30 may generate the notification information containing the warning notification for each distance between the vehicle and the wall surface or the curb.

In addition, when the collision is predicted, the controller 30 may generate the braking information when the distance between the vehicle and the wall surface or the curb is smaller than the preset distance.

In this regard, the controller 30 may provide the generated notification information to the notification device 41 to provide the collision warning to the driver, and provide the braking information to the braking device 42 to stop the vehicle.

In addition, the collision avoidance system for the vehicle according to one embodiment of the present disclosure may provide the virtual map generated based on the image information and the distance information respectively provided from the camera and the ultrasonic sensor, and the expected movement trajectory generated based on the steering information and the speed information respectively provided from the steering sensor and the speed sensor to the notification device 41, thereby providing the virtual map and the expected movement trajectory to the driver as the visual information.

In addition, the collision avoidance system for the vehicle according to one embodiment of the present disclosure may provide a guideline that may avoid the collision to the notification device 41 when the collision is predicted, thereby providing the guideline to the driver as at least one of the visual information or the auditory information.

Various implementations of the devices (e.g., operation determining device) and the controller described herein may be realized in digital electronic circuitry, integrated circuitry, a field programmable gate array (FPGA), an application specific integrated circuit (ASIC), computer hardware, firmware, software, and/or combinations thereof.

A collision avoidance method of the collision avoidance system for the vehicle according to one embodiment of the present disclosure will be described with reference to FIG. 2 as follows.

Referring to FIG. 2, the vehicle collision avoidance method according to one embodiment of the present disclosure may include a parking lot entrance determination operation (S1), a camera image recognition operation (S2), an ultrasonic sensor information collection operation (S3), a 2D map generation operation (S4), an expected movement trajectory calculation operation (S5), a collision possibility determination operation (S6), a normal travel operation (S7), a warning and braking operation (S8), and a guideline provision operation (S9).

The parking lot entrance determination operation (S1) may include an operation of determining that the vehicle is traveling at the inclined entrance and exit of the parking lot when the vehicle has arrived at the parking lot based on the location information of the vehicle provided from the navigation 11 and when the pitch angle exceeds or is below the preset range based on the inclination information provided from the pitch sensor 12.

The camera image recognition operation (S2) may include an operation of recognizing the wall surface and the curb of the entrance and exit based on the image obtained from the camera 16 installed at a front portion of the vehicle when it is determined that the vehicle is traveling at the inclined entrance and exit of the parking lot.

The ultrasonic sensor information collection operation (S3) may include an operation of collecting the information about the distance to the wall surface and the width and the vertical dimension of the curb obtained from the ultrasonic sensor 15 when it is determined that the vehicle is traveling at the inclined entrance and exit of the parking lot.

The 2D map generation operation (S4) may include an operation of generating the virtual two-dimensional map of the wall surface and the curb of the inclined entrances and exits at which the vehicle is traveling based on the information recognized in the camera image recognition operation (S2) and the information collected in the ultrasonic sensor information collection operation (S3).

The expected movement trajectory calculation operation (S5) may include an operation of calculating the expected movement trajectory of the vehicle based on the steering angle of the vehicle provided from the steering sensor 13 and the speed of the vehicle provided from the speed sensor 14.

The collision possibility determination operation (S6) may include an operation of predicting whether the vehicle will collide with the wall surface or the curb of the inclined entrance and exit when the vehicle travels with the expected movement trajectory by matching the virtual 2D map and the expected movement trajectory to each other based on specifications (the overall length, the overall width, and the location of each wheel) of the vehicle.

When the collision of the vehicle is predicted in the collision possibility determination operation (S6) (Yes), the warning and braking operation (S8) may be performed.

On the other hand, when the collision of the vehicle is not predicted in the collision possibility determination operation (S6) (No), the normal travel operation (S7) may be performed.

The warning and braking operation (S8) may include an operation of providing the warning notification to the driver for each distance between the vehicle and the obstacle (the wall surface or the curb) likely to collide with the vehicle when the collision of the vehicle is predicted, and stopping the vehicle when the distance between the vehicle and the obstacle is smaller than the preset distance.

The guideline provision operation (S9) may include an operation of providing the guideline for avoiding the collision of the vehicle to the driver.

The normal travel operation (S7) may include an operation in which the vehicle travels in the indoor parking lot including the inclined entrance and exit without the predicted collision possibility.

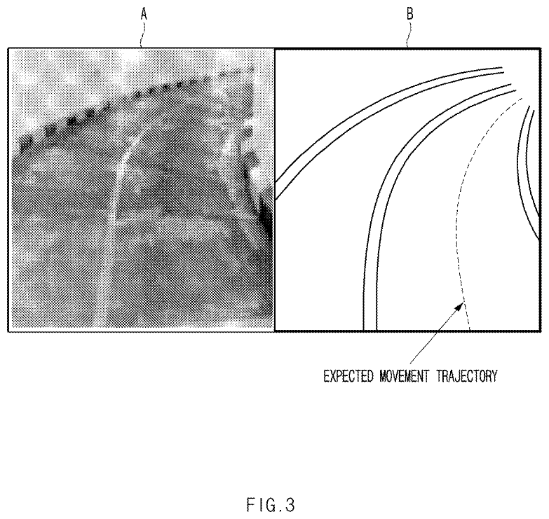

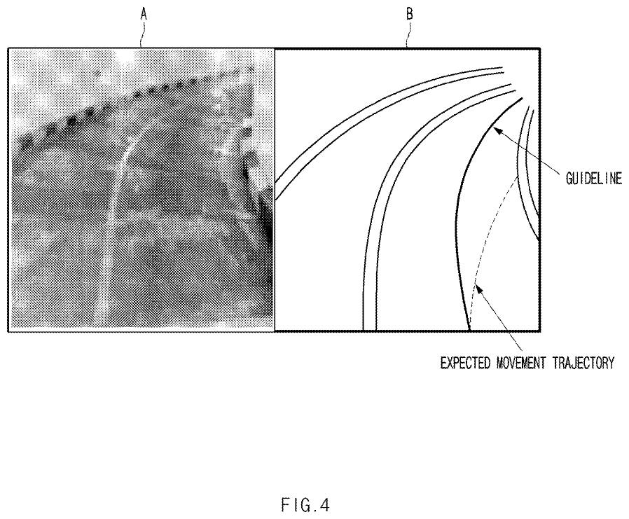

FIGS. 3 and 4 are diagrams for illustrating a collision avoidance system for a vehicle according to an embodiment of the present disclosure.

In particular, FIGS. 3 and 4 may show a screen in which the virtual map, the expected movement trajectory of the vehicle, and the guideline of the collision avoidance system for the vehicle according to one embodiment of the present disclosure are realized on a display device of the vehicle.

Referring to FIG. 3, an image of a region in front of and beneath the vehicle obtained from the front camera of the vehicle may be displayed on a left half screen A of the display device installed in the vehicle, and the virtual map and the expected movement trajectory of the vehicle may be displayed on a right half screen B.

In this regard, FIG. 3 may show a case in which the collision of the vehicle with the wall surface or the curb of the virtual map is not expected based on the expected movement trajectory of the vehicle.

Referring to FIG. 4, the image of the region in front of and beneath the vehicle obtained from the front camera of the vehicle may be displayed on the left half screen A of the display device installed in the vehicle, and the virtual map, the expected movement trajectory of the vehicle, and the guideline may be displayed on the right half screen B.

In this regard, FIG. 4 may show the guideline of when the collision of the vehicle with the wall surface or the curb of the virtual map is expected based on the expected movement trajectory of the vehicle.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The present technology may prevent the accident that damages the vehicle on the curved slope of the narrow width, thereby increasing the driving convenience of the driver and preventing the collision accident.

In addition, various effects directly or indirectly identified through this document may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system for a vehicle to avoid a collision, the system comprising:
an operation determining device to determine whether the vehicle has entered a parking lot based on location information and inclination information of the vehicle; and
a controller configured to:
generate a virtual map about an obstacle on a curved road in the parking lot based on image information and distance information when it is determined that the vehicle has entered the parking lot;
generate an expected movement trajectory of the vehicle based on steering information and speed information of the vehicle; and
predict the collision between the obstacle in the virtual map and the vehicle depending on the expected movement trajectory based on the virtual map and the expected movement trajectory.

2. The system of claim 1, wherein the operation determining device determines that, when it is determined that the vehicle has reached the parking lot based on the location information, the vehicle is travelling on a slope of the parking lot when a pitch angle exceeds or is below a preset range based on the inclination information.

3. The system of claim 1, wherein the obstacle includes a wall surface and a curb of the curved road.

4. The system of claim 3, wherein the controller is further configured to:
when receiving information obtained by determining that the vehicle has entered the parking lot from the operation determining device,
recognize the wall surface and the curb of the curved road based on the image information obtained from a region in front of the vehicle; and
generate the virtual map based on the recognized wall surface and curb.

5. The system of claim 4, wherein the controller is further configured to correct an error of the virtual map with respect to the wall surface and the curb based on the distance information provided from an ultrasonic sensor.

6. The system of claim 1, wherein the controller is further configured to predict a collision between the vehicle and a wall surface or a curb in the virtual map when the vehicle travels with the expected movement trajectory based on an overall width, an overall length, and a location of each wheel of the vehicle.

7. The system of claim 6, wherein the controller is further configured to generate warning notification information for each collision-predicted-distance between the vehicle and the wall surface or the curb when the collision between the vehicle and the wall surface or the curb in the virtual map is predicted.

8. The system of claim 7, further comprising:
a notification device to provide the warning notification information to a driver as at least one of visual information or auditory information when receiving the warning notification information.

9. The system of claim 6, wherein the controller is further configured to generate braking information when the collision between the vehicle and the wall surface or the curb in the virtual map is predicted and when a distance between the vehicle and the wall surface or the curb predicted to collide with the vehicle is below a preset distance.

10. The system of claim 9, further comprising:
a braking device to stop the vehicle when receiving the braking information.

11. The system of claim 1, further comprising:
a navigation to provide the location information,
a pitch sensor to provide the inclination information,
a camera installed at a front portion of the vehicle to provide the image information,
an ultrasonic sensor to provide the distance information,
a steering sensor to provide the steering information, and
a speed sensor to provide the speed information.

12. The system of claim 1, wherein the virtual map and the expected movement trajectory are provided to a driver as visual information by a display device installed in the vehicle.

13. A method for a vehicle to avoid a collision, the method comprising:
determining, by an operation determining device, whether the vehicle is traveling on an inclined curved road of a parking lot;
recognizing, by a controller, a wall surface and a curb of the inclined curved road based on an image of a region in front of the vehicle;
generating, by the controller, a virtual map about the recognized wall surface and curb;
calculating, by the controller, an expected movement trajectory of the vehicle based on steering information and speed information; and
predicting, by the controller, a collision between the vehicle and the wall surface or the curb in the virtual map based on the expected movement trajectory and the virtual map.

14. The method of claim 13, further comprising:
correcting, by the controller, an error of the virtual map based on distance information collected from an ultrasonic sensor.

15. The method of claim 13, wherein the predicting of the collision includes:
predicting, by the controller, the collision between the vehicle and the wall surface or the curb in the virtual map when the vehicle travels with the expected movement trajectory based on an overall width, an overall length, and a location of each wheel of the vehicle.

16. The method of claim 13, further comprising:
providing, by the controller, a warning notification information to a driver for each collision-predicted-distance between the vehicle and the wall surface or the curb when the collision is predicted in the predicting of the collision.

17. The method of claim 13, further comprising:
stopping the vehicle, by a braking device, when the collision is predicted in the predicting of the collision and when a collision-predicted-distance between the wall surface or the curb and the vehicle is smaller than a preset distance.
